(19) United States
(12) Patent Application Publication
(10) Pub. No.: US 2011/0111326 A1
(43) Pub. Date: May 12, 2011

(54) FUEL CELL DEVICE HAVING A WATER RESERVOIR

(76) Inventors: Paravastu Badrinarayanan, Manchester, CT (US); Timothy W. Patterson, West Hartford, CT (US); Robert Mason Darlling, South Windsor, CT (US)

(21) Appl. No.: 13/003,582

(22) PCT Filed: Sep. 12, 2008
(86) PCT No.: PCT/US08/76094

§ 371 Date: Jan. 11, 2011

(51) Int. Cl. H01M 8/04

(52) U.S. Cl. 429/514

(57) ABSTRACT

An exemplary fuel cell device includes an electrode assembly. A hydrophobic gas diffusion layer is on a first side of the electrode assembly. A first, solid, non-porous plate is adjacent the hydrophobic gas diffusion layer. A hydrophilic gas diffusion layer is on a second side of the electrode assembly. A second flow field plate is adjacent the hydrophilic gas diffusion layer. The second flow field plate has a porous portion facing the hydrophilic gas diffusion layer. The porous portion is configured to absorb liquid water from the electrode assembly when the fuel assembly device is shutdown.

### BACKGROUND

Fuel cells are useful for generating electrical power. An electrochemical reaction occurs at a proton exchange membrane. Flow field plates are provided on each side of the membrane to carry reactants such as hydrogen and oxygen to the membrane for purposes of generating the electrical power. The flow field plates in some examples are solid, non-porous plates. Other example fuel cell arrangements include porous plates. There are advantages and drawbacks associated with each type of arrangement.

In solid plate fuel cell arrangements, for example, it is necessary to perform a flow field purge at shutdown to remove liquid water from the flow field channels. During the electrochemical reaction, liquid water may be produced as a phase of byproduct water depending on temperature. Such liquid water tends to collect in the flow fields on the cathode side. If that liquid water remains there and temperatures drop sufficiently low, it will freeze and interfere with the ability to start up the fuel cell after it has been shutdown.

Typical purge procedures include using an air blower and a hydrogen recycle blower to remove the liquid water. One disadvantage of using such a purge procedure is that it introduces relatively large parasitic loads on the system when the fuel cell is no longer producing electrical power. Other issues associated with usual purge procedures are added system complexities and the risk of drying out portions of the fuel cell stack.

There is a need for a water management arrangement and strategy that reduces or eliminates purge requirements.

### SUMMARY

An exemplary fuel cell device includes an electrode assembly. A hydrophobic gas diffusion layer is on a first side of the electrode assembly. A first, solid, non-porous plate is adjacent the hydrophobic gas diffusion layer. A hydrophilic gas diffusion layer is on a second side of the electrode assembly. A second flow field plate is adjacent the hydrophilic gas diffusion layer. The second flow field plate has a porous portion facing the hydrophilic gas diffusion layer. The porous portion is configured to absorb liquid water from the electrode assembly when the fuel cell device is shutdown.

An exemplary method of managing liquid water distribution in a fuel cell device that has an electrode assembly, a hydrophobic gas diffusion layer on a first side of the assembly and a solid, non-porous plate adjacent the hydrophobic gas diffusion layer includes providing a hydrophilic gas diffusion layer on a second side of the electrode assembly. A second flow field plate is provided adjacent the hydrophilic gas diffusion layer. The second flow field plate has a porous portion facing the hydrophilic gas diffusion layer. Liquid water is absorbed from the electrode assembly by the porous portion when the fuel cell device is shutdown.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example fuel cell device.

FIG. 2 schematically illustrates selected features of selected portions of the embodiment of FIG. 1.

### DETAILED DESCRIPTION

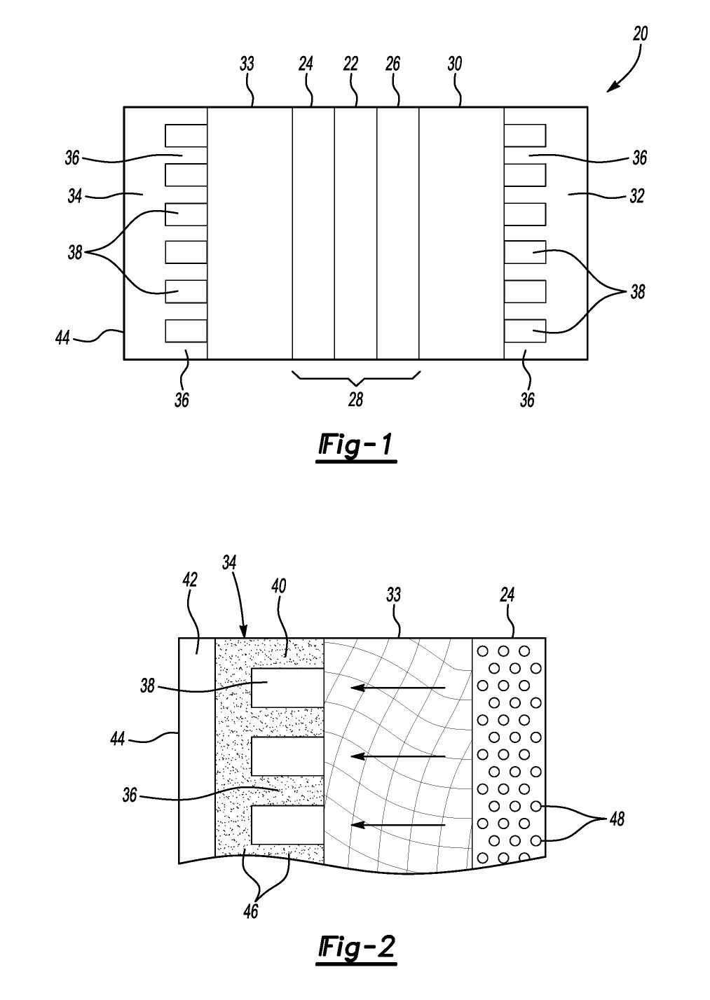

FIG. 1 schematically shows portions of an example fuel cell device 20. A proton exchange membrane 22 is between catalyst layers 24 and 26. The membrane 22 and the catalyst layers 24 and 26 are collectively referred to as an electrode assembly 28. A hydrophobic gas diffusion layer 30 is on a first side of the electrode assembly. In this example, the hydrophobic gas diffusion layer 30 is adjacent the cathode catalyst layer 26. A first flow field plate 32 is solid and non-porous in this example. The first flow field plate 32 is adjacent the hydrophobic gas diffusion layer 30.

A hydrophilic gas diffusion layer 33 is provided on an opposite side of the electrode assembly 28. In this example, the hydrophilic gas diffusion layer 33 is adjacent the anode catalyst layer 24. Accordingly, the hydrophilic gas diffusion layer 33 is on an anode side of the example fuel cell device 20.

A second flow field plate 34 is provided adjacent the hydrophilic gas diffusion layer 33.

The first flow field plate 32 and the second flow field plate 34 have a plurality of ribs 36 with a plurality of flow field channels 38 between the ribs 36. The flow field channels 38 allow for introducing the reactants (e.g., hydrogen and oxygen) for accomplishing the electrochemical reaction at the electrode assembly 28.

A byproduct of the electrochemical reaction is liquid water. The liquid water tends to collect in the cathode side of the assembly within the flow field channels 38, for example. The second flow field plate 34 on the anode side of the fuel cell device includes a porous portion configured to absorb liquid water from the electrode assembly when the fuel cell device is shutdown.

FIG. 2 schematically shows one example configuration of the second flow field plate 34. In this example, a porous portion 40 of the second flow field plate 34 is facing the hydrophilic gas diffusion layer 33. In this example, the second flow field plate 34 includes a solid, non-porous portion 42 along a surface 44, which faces away from the electrode assembly 28.

In one example, the second flow field plate 34 is entirely porous.

When the fuel cell device 20 is shutdown, liquid water will be absorbed from the electrode assembly 28 into the porous portion 40 of the second flow field plate 34. Liquid water moves in a direction across the hydrophilic gas diffusion layer 33 as schematically shown by the arrows in FIG. 2. In this sense, the hydrophilic gas diffusion layer 33 operates as a path for the liquid water to travel from the electrode assembly to the porous portion 40.

In one example, the hydrophilic gas diffusion layer 33 comprises a tin-oxide treated gas diffusion layer to make it wettable. In another example, the hydrophilic gas diffusion layer 33 comprises a carbon cloth without any hydrophobic agents added to it in which the carbon cloth has sufficient hydrophilicity or wettability to provide a path for the liquid water to move toward the porous portion 40 when the fuel cell is shutdown.

In this example, the porous portion 40 includes at least some of the ribs 36 that are in contact with the hydrophilic gas diffusion layer 33. In this example, all of the ribs of the second flow field plate 34 are porous. Additionally, some of the body of the illustrated second flow field plate 34 adjacent the ribs 36 is also part of the porous portion 40.

As can be appreciated from FIG. 2, the porous portion 40 includes a plurality of pores 46. The catalyst layer 24 includes a plurality of pores 48. The pores 46 and 48 are respectively configured or arranged to facilitate absorbing water into the porous portion 40. For example, the pores 48 of the catalyst layer 24 may be less hydrophilic than the pores 46. In another example, the pore volumes of the catalyst layer 24 and the porous portion 40 are selected to facilitate water migration to the porous portion 40 after shut down.

In the illustrated example, the pores 46 of the porous portion 40 have a first size and the pores 48 have a second pore size. The second pore size 48 is at least as large as the pore size 46. In this example, the second pore size 48 is larger such that the pores 46 in the porous portion 40 are smaller than the pores 48 of the catalyst layer 24. Having smaller pore size in the porous portion 40 compared to the catalyst layer 24 facilitates drawing water into the porous portion 40. Providing the smaller pores facilitates absorbing water into the porous portion 40 and using the porous portion 40 as a reservoir for the water.

By drawing water into the porous portion 40, excess byproduct liquid water can be removed from the cathode side of the fuel cell device and stored in the reservoir provided by the porous portion 40.

By drawing water from the electrode assembly into the porous portion 40 on the anode side of the fuel cell device, it is possible to reduce the amount of byproduct liquid water that remains in the cathode side after shutdown. During normal fuel cell device operation, the porous portion 40 remains essentially dry. The inlet gases flowing through the flow field channels 38 tends to keep the porous portion 40 dry during normal operation. Upon shutdown, the porous portion 40 begins to absorb liquid water that is present within the fuel cell device.

With the disclosed example configurations including the hydrophobic gas diffusion layer and the second flow field plate having at least a portion that is porous provides a reservoir for storing excess byproduct water in a manner that facilitates avoiding problems with a frozen start cycle in low temperature conditions, for example.

In some examples, a modified purge cycle will also be used along with the porous portion 40 for removing water from the cathode side of the fuel cell device. The absorbing feature of the porous portion 40 makes it possible to reduce the time of a purge cycle. This reduces parasitic load at shutdown. In some examples, no purge cycle is needed.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A fuel cell device, comprising:
an electrode assembly;
a hydrophobic gas diffusion layer on a first side of the electrode assembly;
a first, solid, non-porous plate adjacent the hydrophobic gas diffusion layer;
a hydrophilic gas diffusion layer on a second side of the electrode assembly; and
a second flow field plate adjacent the hydrophilic gas diffusion layer, the second flow field plate having a porous portion facing the hydrophilic gas diffusion layer, the porous portion being configured to absorb liquid water from the electrode assembly when the fuel cell device is shut down.

2. The fuel cell device of claim 1, wherein the hydrophilic gas diffusion layer is operative as a path for the liquid water to move from the electrode assembly to the porous portion of the second flow field plate.

3. The fuel cell device of claim 1, wherein the flow field plate includes a plurality of ribs and fuel flow channels between the ribs, the porous portion including at least some of the ribs.

4. The fuel cell device of claim 1, wherein the flow field plate porous portion has pores and the electrode assembly includes a catalyst layer immediately adjacent the hydrophilic gas diffusion layer, the catalyst layer is porous having catalyst layer pores, the pores and the catalyst layer pores being configured to facilitate water absorption into the porous portion.

5. The fuel cell device of claim 4, wherein the pores of the porous portion have a first size and the catalyst layer pores have a second size that is at least as large as the first size.

6. The fuel cell device of claim 5, wherein the second size is larger than the first size.

7. The fuel cell device of claim 4, wherein the catalyst layer pores are less hydrophilic than the pores of the porous portion.

8. The fuel cell device of claim 1, wherein the entire second flow field plate is porous.

9. The fuel cell device of claim 1, wherein the second flow field plate includes a solid, non-porous layer on a side facing opposite the hydrophilic gas diffusion layer.

10. The fuel cell device of claim 1, wherein the hydrophilic gas diffusion layer and the second flow field plate are on an anode side of the electrode assembly.

11. The fuel cell device of claim 1, wherein the porous portion of the second flow field plate remains essentially dry during operation of the fuel cell device.

12. A method of managing fluid in a fuel cell device including an electrode assembly, a hydrophobic gas diffusion layer on a first side of the electrode assembly and a first, solid, non-porous plate adjacent the hydrophobic gas diffusion layer, the method comprising the steps of:
providing a hydrophilic gas diffusion layer on a second side of the electrode assembly;
providing a second flow field plate adjacent the hydrophilic gas diffusion layer, the second flow field plate having a porous portion facing the hydrophilic gas diffusion layer; and
absorbing liquid water from the electrode assembly into the porous portion when the fuel cell device is shut down.

13. The method of claim 12, wherein the porous portion remains essentially dry during operation of the fuel cell.

14. The method of claim 12, wherein liquid water in the electrode assembly moves through the hydrophilic gas diffusion layer into the porous portion when the fuel cell is shut down.

15. The method of claim 12, wherein the flow field plate porous portion has pores and the electrode assembly includes a catalyst layer immediately adjacent the hydrophilic gas diffusion layer, the catalyst layer is porous having catalyst layer pores, the pores of the porous portion and the catalyst layer pores being configured to facilitate water absorption into the porous portion.

16. The method of claim 15, wherein the pores of the porous portion have a first size and the catalyst layer pores have a second size that is at least as large as the first size.

17. The method of claim 16, wherein the second size is larger than the first size.

18. The method of claim 15, wherein the catalyst layer pores are less hydrophilic than the pores of the porous portion.

19. The method of claim 12, wherein the hydrophilic gas diffusion layer and the second flow field plate are on an anode side of the electrode assembly.
